(19) United States
(12) Patent Application Publication
(10) Pub. No.: US 2021/0351700 A1
(43) Pub. Date: Nov. 11, 2021

(54) CURRENT BOOST FOR WIRELINE POWERED TOOLS

(71) Applicant: Halliburton Energy Services, Inc., Houston, TX (US)

(72) Inventor: Ramon Hernandez MARTI, Houston, TX (US)

(21) Appl. No.: 16/332,974

(22) PCT Filed: Apr. 11, 2018
(86) PCT No.: PCT/US2018/027035

§ 371 Date: Mar. 13, 2019

(51) Int. Cl. H02M 3/158; H02M 1/00; E21B 4/04; E21B 23/00; E21B 23/14; H02P 7/292

(52) U.S. Cl. CPC H02M 3/1582; H02M 1/0032; E21B 4/04; H02P 2201/11; E21B 23/14; H02P 7/292; E21B 23/001

(57) ABSTRACT

A current booster includes a buck-type converter including an input node, an output node, an inductor connected in series between the input and output nodes, a first capacitor connecting between the output node and ground, a second capacitor connecting between the input node and ground, a first switch connected in series between the input node and the inductor, and a second switch connecting a node between the first switch and the inductor to ground. A controller is operatively connected to control switching of the first and second switches. The controller includes logic configured to drive switching of the first and second switches in a first mode to maintain voltage at the output node if current at the input node is below a set point, and in a second mode to maintain constant current at the input node if current at the input node reaches the set point.

### BACKGROUND OF THE INVENTION

### 1. Field of the Invention

The present disclosure relates to wireline powered tools, and more particularly to wireline powered oil well tools such as tractors, and operations such as drilling, cutting, and milling.

### 2. Description of Related Art

Traditional oil well tractors stall when encountering restrictions in a well bore, especially if operating at high speed. The cause is the current limitation that the logging cable resistance represents.

In a traditional tractor system, the motor can be connected to the logging cable and the surface voltage on the logging cable can be adjusted to control the speed of the tractor. As torque on the motor of the tractor increases, e.g., when encountering a restriction in the well bore or casing, the motor and cable current increase, and downhole voltage on the logging cable and motor decrease. The product of the motor current and the motor voltage is power, which can be represented by a parabola that has its maximum where downhole voltage is half the surface supply voltage. As the torque demand increases past this point, voltage decreases and the motor stalls when the torque reaches twice the torque value for the maximum of the power parabola. At this point, since the tool head voltage is zero, no other downhole electronic circuits can be powered by the logging cable either.

Motor velocity is proportional to the voltage driving the motor, and in traditional systems the operator must constantly modulate the surface supply voltage to maintain a given speed when the torque requested by the well conditions changes. The same effects can apply to other downhole operations such as drilling, cutting, and milling.

The conventional techniques have been considered satisfactory for their intended purpose. However, there is an ever present need for improved torque for wireline powered tools. This disclosure provides a solution for this need.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of a current booster constructed in accordance with the present disclosure, showing a voltage source and a load connected to a buck-type converter;

FIG. 2 is a schematic view of the buck-type converter of FIG. 1, showing a controller, switches, and a selector;

FIG. 3 is a graph showing voltage, current, and power as functions of torque for a cable and motor connected to the buck-type converter of FIG. 2; and

FIG. 4 is a schematic side-elevation view of the current booster of FIG. 1, showing the current booster in a tractor in a well bore.

### DETAILED DESCRIPTION OF THE PREFERRED EMBODIMENTS

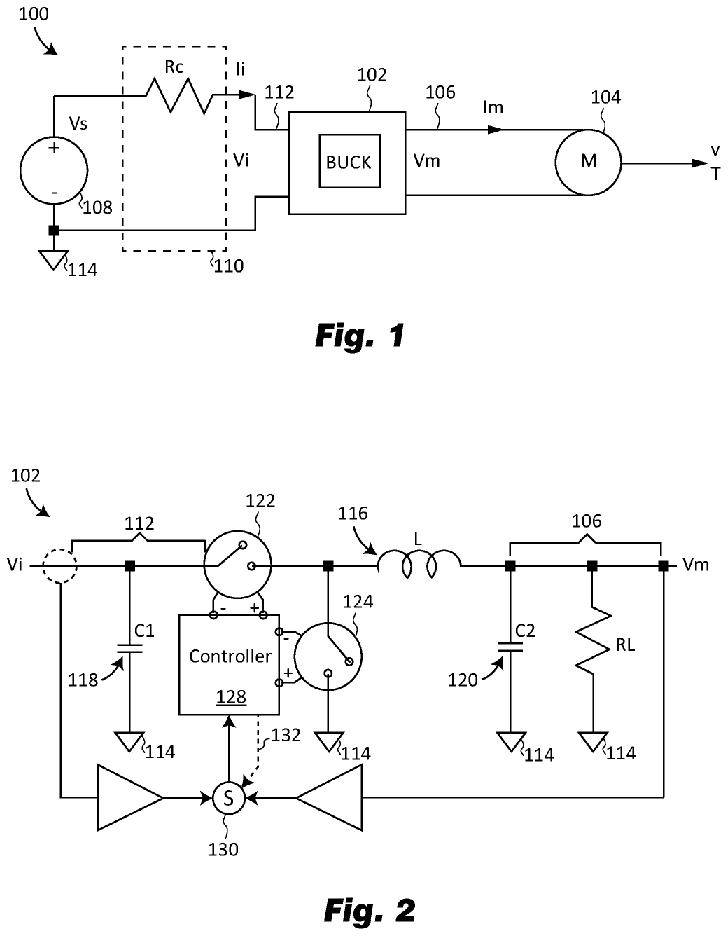

Reference will now be made to the drawings wherein like reference numerals identify similar structural features or aspects of the subject disclosure. For purposes of explanation and illustration, and not limitation, a partial view of an exemplary embodiment of a current booster in accordance with the disclosure is shown in FIG. 1 and is designated generally by reference character 100. Other embodiments of current boosters in accordance with the disclosure, or aspects thereof, are provided in FIGS. 2-4, as will be described. The systems and methods described herein can be used to reduce voltage, and boost current, to a load such as a motor in a tool connected to its voltage source by wireline. This can be used to increase torque in downhole tools such as oil well tractors, for example.

The current booster 100 includes a buck-type converter 102. A load 104 can be connected to be powered from an output node 106 of the buck-type converter 102, and a voltage source 108 can be connected by a wireline 110 to an input node 112 of the buck-type converter 102 for providing power to the load 104 conditioned by the buck-type converter 102. The load 102 can include a motor, e.g. a brushless direct current motor (BLDC). For example, the load 102 can be a motor that is connected to drive a downhole tool, such as a tractor, a drill, a mill, a cutter, or the like. In FIG. 1, the resistance of the wireline 110 is denoted as Rc, the current through the wireline 110 is denoted as Ii, the voltage of the voltage source 108 (e.g. a voltage source at the surface for a well bore) is denoted as Vs, and the voltage across the input node 112 of the buck-type converter 102 and ground 114 is denoted Vi. In FIG. 1, the current supplied from the buck-type converter 102 through the load 104 is denoted as Im, the voltage the buck-type converter 102 applies across the load 104 is denoted Vm, and the torque and velocity are denoted T and v, respectively, wherein the load 104 is a motor by way of example.

With reference now to FIG. 2, buck-type converter 102 is shown in greater detail. The buck-type converter 102 is shown in FIG. 2, howeve those skilled in the art will readily appreciate that other configurations correspond to different topologies that can be used in a similar way without departing from the scope of this disclosure such as: a synchronous buck, a fly-buck™ topology available from Texas Instruments of Dallas, Tex., single switch forward, two switch forward, bridge, resonant, and/or quasi-resonant. An inductor 116 with inductance L is connected in series between the input node 112 and the output node 106. A first capacitor 118 with capacitance C1 connects between the input node 112 and ground 114. A second capacitor 120 with capacitance C2 connects between the output node 106 and ground 114. The first and second capacitors 118 and 120 average the input and output voltages Vi and Vm, respectively over the two switch states of the buck-type converter 102. A first switch 122 is connected in series between the input node 112 and the inductor 116, and a second switch 124 connects a node 126 that is in series between the first switch 122 and the inductor 116 to ground 114. A controller 128 is operatively connected to control switching of the first and second switches 122 and 124. The first switch 122 can include a MOSFET, and the second switch 124 can include a diode (e.g. in a Buck converter configuration noting that a synchronous buck configuration uses a MOSFET transistor in place of the diode) configured to switch based on voltage during a duty cycle of the buck-type 102 converter in the first and second modes without direct input from the controller 128, for example. Any other suitable type of switches can be used without departing from the scope of this disclosure.

The controller 128 includes logic configured to drive switching of the first and second switches 122 and 124 in a first mode to maintain voltage Vm at the output node 106 if current Ii at the input node 112 is below a set point, and in a second mode to maintain constant current Ii at the input node 112 if current Ii at the input node 112 reaches the set point. The timing of switching of switches 122 and 124 give the buck-type converter a duty cycle.

With continued reference to FIG. 2, a selector 130 is operatively connected to each of the input and output nodes 112 and 106, respectively, and is also operatively connected to the controller 128 to select whether input for the controller 128 is provided from the input node 112 or from the output node 106. The controller 128 and the selector 130 include logic to drive switching of the first and second switches 122 and 124 in the first mode wherein voltage at the output node 106 controls the duty cycle of the buck-type converter 102 to maintain voltage Vm at the output node 106 if current at the input node Ii is below the set point described above, and to drive switching of the first and second switches 122 and 124 in the second mode wherein input from the input node 112 controls the duty cycle of the buck-type converter 102 to maintain constant current Ii at the input node 112 if current Ii at the input node 112 is equal to or above the set point. The selector 130 can include a diode switch, a controlled switch from a comparator configured to switch on the set point, and/or a switch controlled by a signal from the controller 128, e.g., by way of line 132 which is shown in broken lines in FIG. 2 to indicate it is optional.

The controller 128 can be operatively connected to receive current Ii at the input node 112, as indicated by the broken line circle in FIG. 2, to control switching of the first and second switches 122 and 124 in the second mode. A current measurement resistor, a Hall Effect device, and/or any other suitable type of current sensor can be operatively connected as indicated by the dashed circle in FIG. 2, to measure current Ii at the input node 112 for use input to the controller 128. It is also contemplated that the controller 128 can be operatively connected to receive voltage Vi at the input node 112, e.g., by a connection from the dashed circle in FIG. 2, through the selector 130 to the controller 128, to control switching of the first and second switches 122 and 124 in the second mode.

The controller 128 can be programmed with machine readable instructions to switch between the first and second modes at the set point, wherein the set point varies in a way that accounts for expected resistance variations across the load 104 of FIG. 1. It is also contemplated that the controller 128 can be programmed with machine readable instructions to switch between the first and second modes at the set point wherein the set point varies in a way that changes to be refined based on voltage and/or current measurements locally or using telemetry.

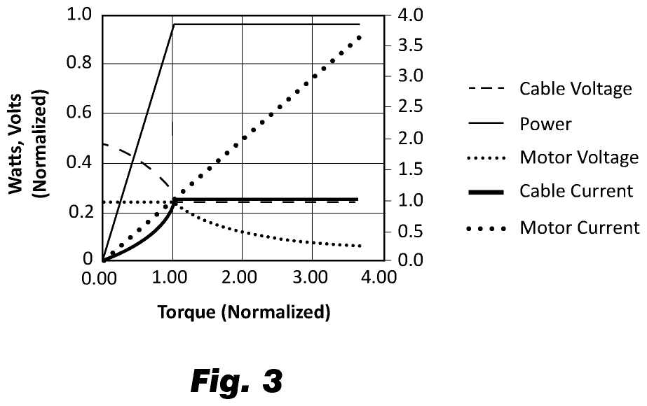

With reference now to FIG. 3, as torque demand at the motor (e.g., where the load 104 of FIG. 1 is a motor) initially increases from zero towards 1.0 on the normalized torque axis, the buck-type converter 102 of FIG. 1 behaves like a buck converter, switching the switches 122 and 124 (shown in FIG. 2) on a duty cycle to maintain the voltage Vm driving the motor constant. However, upon reaching the point at normalized toque 1.0, a feedback loop controlled by the input current Ii (or input voltage Vi) takes over and the buck-type converter 102 changes the switching duty cycle for switches 122 and 124 (shown in FIG. 2) to maintain the current Ii through the wireline 110 (shown in FIG. 1) at a constant level, 1.0 on the normalized Amps scale in this example. In this second mode, as the motor current Im increases, the duty cycle decreases, causing the motor voltage Vm to also decrease as an inverse function. At the same time the decrease in duty cycle will result in the desired increase in motor current Im or current boost. This way, the motor current Im continues to rise with increasing torque, while voltage Vm follows an inverse function that reaches zero only at infinity, i.e. motor torque is no longer limited by the power deliverable by the cable or wireline 110 of FIG. 1. Motor torque may still be limited by circuit elements, motor design, and other system components, but not by power deliverable by the cable. Since the voltage Vm never actually reaches zero as a result of increased motor torque in this example, power of other electrical circuits at the end of wireline 110 is always allowed within the power limits available from the wireline 110.

Maintaining input current Ii in the second mode can include capping the input current Ii in the second mode, i.e. enforcing an upper limit the input current Ii, after input current Ii to the current booster 100 reaches the set point and thereafter returning the current booster 100 to the first mode if demand from the load 104 allows current Ii to the current booster 100 to drop below the set point. It is also contemplated that switching the current booster 100 from the first mode to the second mode can be performed at the set point wherein the set point corresponds to a point of maximum power transfer through the current booster 100 to the load 104, e.g., at the top of the power curve in FIG. 3. It is not required to set the set point this high, however doing so can maximize the motor speed for a given torque. It is also contemplated, e.g., where the load 104 of FIG. 1 is a brushless direct current motor (BLDC), that the operation of the switches 122 and 124 of FIG. 2 can be coordinated with the speed and torque control capacities of the BLDC, although it can be more difficult to obtain the current boost operation and motor control at the same time.

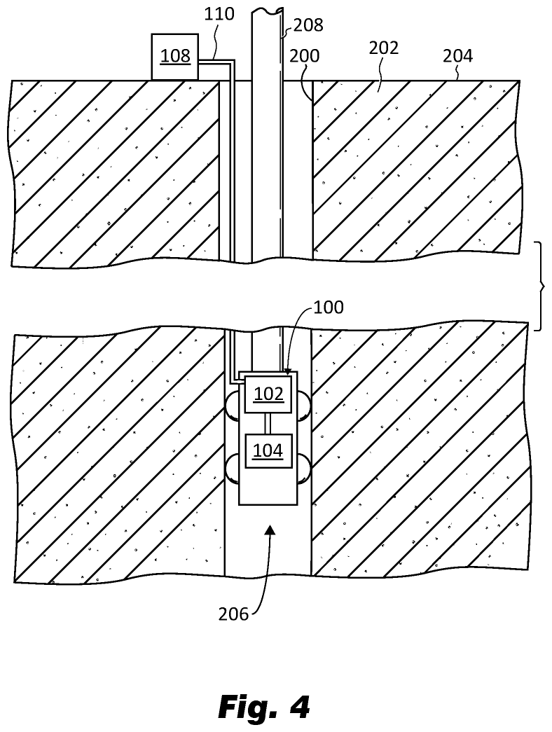

A caveat is that the set point should not cause a voltage drop over the cable resistance Rc greater than half the source voltage Vs to avoid regulator instability. The cable resistance Rc will change with temperature, e.g., as a cable goes deeper into a well, with the weather, or due to self-heating caused by the current circulating through the cable (e.g. wireline 110 of FIG. 1). The current set point can be pre-programmed, e.g., in controller 128 of FIG. 2, with sufficient margin to account for resistance variations, or the current booster 100 can make voltage and current measurements to track changes and refine the value of the current set point either locally of via telemetry. Those skilled in the art having the benefit of this disclosure will readily appreciate that dimensioning of the switches 122 and 124, the inductor 116, and the capacitors 118 and 120 (all shown in FIG. 2), one must consider the large currents that can be delivered in the second mode, making the buck-type converter 102 of FIG. 2 quite different from a simple voltage regulator. With reference now to FIG. 4, a well bore 200 is shown extending from a surface 204 (e.g.

the surface of the earth, a sea bed, or the like) through an earth formation 202. The voltage source 108 is shown at the surface 204, connected by the wireline 110 to the current booster 100. The buck-type converter 102 of the current booster 100 drives the motor 104 to propel the tractor 206 through the well bore 200 to advance the tubing 208 into the well bore 200. As the tractor 206 encounters constrictions, changes in direction, or the like, in the well bore 200, the torque demand increases. But relative to traditional tractors, the tractor 206 provides boosted current to the motor 104 in the second mode of operation described above. Those skilled in the art having the benefit of this disclosure will readily appreciate that downhole tractors are an exemplary application, and that current boosters as disclosed herein can readily be applied to any suitable load without departing from the scope of this disclosure.

Accordingly, as set forth above, the embodiments disclosed herein may be implemented in a number of ways. For example, in general, in one aspect, the disclosed embodiments relate to a current booster. The current booster includes a buck-type converter including an input node, an output node, an inductor connected in series between the input and output nodes, a first capacitor connecting between the output node and ground, a second capacitor connecting between the input node and ground, a first switch connected in series between the input node and the inductor, and a second switch connecting a node between the first switch and the inductor to ground. A controller is operatively connected to control switching of the first and second switches. The controller includes logic configured to drive switching of the first and second switches in a first mode to maintain voltage at the output node if current at the input node is below a set point, and in a second mode to maintain constant current at the input node if current at the input node reaches the set point.

In general, in another aspect, the disclosed embodiments relate to a method of boosting current. The method includes supplying electrical power to a load through a current booster, wherein the current booster in a first mode maintains voltage applied to the load if current input to the current booster is below a set point, and wherein the current booster in a second mode maintains input current to the current booster if the input current to the current booster reaches the set point.

In accordance with any of the foregoing embodiments, a selector can be operatively connected to each of the input and output nodes, and operatively connected to the controller to select whether input for the controller is provided from the input node or from the output node. The controller and the selector can include logic to drive switching of the first and second switches in the first mode wherein voltage at the output node controls buck-type converter duty cycle to maintain voltage at the output node if current at the input node is below a set point, and to drive switching of the first and second switches in the second mode wherein current from the input node controls buck-type converter duty cycle to maintain constant current at the input node if current at the input node is equal to or above the set point.

In accordance with any of the foregoing embodiments, the selector can include at least one of a diode switch, a controlled switch from a comparator configured to switch on the set point, and/or a switch controlled by a signal from the controller.

In accordance with any of the foregoing embodiments, the controller can be operatively connected to receive current at the input node to control switching of the first and second switches in the second mode. Optionally at least one of a current measurement resistor and/or a Hall Effect device can be operatively connected to measure current at the input node for input to the controller. It is also contemplated that the controller can be operatively connected to receive voltage at the input node to control switching of the first and second switches in the second mode.

In accordance with any of the foregoing embodiments, the controller can be programmed with machine readable instructions to switch between the first and second modes at the set point, wherein the set point varies in a way that accounts for expected cable resistance variations. In accordance with any of the foregoing embodiments, the controller can be programmed with machine readable instructions to switch between the first and second modes at the set point wherein the set point varies in a way that changes to be refined based on voltage and/or current measurements locally or using telemetry.

In accordance with any of the foregoing embodiments, the buck-type converter can be configured as at least one of the following configurations: a synchronous buck, a fly-buck™ topology available from Texas Instruments of Dallas, Texas, single switch forward, two switch forward, bridge, resonant, and/or quasi-resonant.

In accordance with any of the foregoing embodiments, the first switch can include a MOSFET.

In accordance with any of the foregoing embodiments, the second switch can include at least one of a diode configured to switch based on duty cycle of the buck-type converter in the first and second modes without direct input from the controller or a MOSFET.

In accordance with any of the foregoing embodiments, a load can be connected to be powered from the output node of the buck-type converter, and a voltage source can be connected by a wireline to the input node of the buck-type converter for providing power to the load conditioned by the buck-type converter. The load can include a motor, optionally wherein the motor is a brushless direct current motor (BLDC), optionally wherein the motor is connected to drive a downhole tool, optionally wherein the downhole tool includes at least one of a tractor, a drill, a mill, and/or a cutter.

In accordance with any of the foregoing embodiments, maintaining input current can include capping the input current in the second mode after input current to the current booster reaches the set point and thereafter returning the current booster to the first mode if demand from the load allows current to the current booster to drop below the set point.

In accordance with any of the foregoing embodiments, switching the current booster from the first mode to the second mode can be performed at the set point wherein the set point corresponds to a point of maximum power transfer through the current booster to the load.

The methods and systems of the present disclosure, as described above and shown in the drawings, provide for current boosters with superior properties including extended operating range for loads on motors in wireline connected downhole tools. While the apparatus and methods of the subject disclosure have been shown and described with reference to preferred embodiments, those skilled in the art will readily appreciate that changes and/or modifications may be made thereto without departing from the scope of the subject disclosure.

1. A current booster comprising:
a buck-type converter including:
an input node;
an output node;
an inductor connected in series between the input and output nodes;
a first capacitor connecting between the output node and ground;
a second capacitor connecting between the input node and ground;
a first switch connected in series between the input node and the inductor; and
a second switch connecting a node between the first switch and the inductor to ground;
a controller operatively connected to control switching of the first and second switches, wherein the controller includes logic configured to drive switching of the first and second switches in a first mode to maintain voltage at the output node if current at the input node is below a set point, and in a second mode to maintain constant current at the input node if current at the input node reaches the set point.

2. The current booster as recited in claim 1, further comprising:
a selector operatively connected to each of the input and output nodes, and operatively connected to the controller to select whether input for the controller is provided from the input node or from the output node, wherein the controller and the selector include logic to drive switching of the first and second switches in the first mode wherein voltage at the output node controls buck-type converter duty cycle to maintain voltage at the output node if current at the input node is below a set point, and to drive switching of the first and second switches in the second mode wherein current from the input node controls buck-type converter duty cycle to maintain constant current at the input node if current at the input node is equal to or above the set point.

3. The current booster as recited in claim 2, wherein the selector includes at least one of:
a diode switch;
a controlled switch from a comparator configured to switch on the set point; and/or
a switch controlled by a signal from the controller.

4. The current booster as recited in claim 1, wherein the controller is operatively connected to receive current at the input node to control switching of the first and second switches in the second mode, optionally further comprising at least one of a current measurement resistor and/or a Hall Effect device operatively connected to measure current at the input node for input to the controller.

5. The current booster as recited in claim 1, wherein the controller is operatively connected to receive voltage at the input node to control switching of the first and second switches in the second mode.6. (Original) The method of claim 1, wherein determining the concentration of particles comprises using a data processing device to evaluate changes in reflectivity of the lubricating fluid.

6. The current booster as recited in claim 1, wherein the controller is programmed with machine readable instructions to switch between the first and second modes at the set point wherein the set point varies in a way that accounts for expected cable resistance variations.

7. The current booster as recited in claim 1, wherein the controller is programmed with machine readable instructions to switch between the first and second modes at the set point wherein the set point varies in a way that changes to be refined based on voltage and/or current measurements locally or using telemetry.

8. The current booster as recited in claim 1, wherein the buck-type converter is configured as at least one of the following configurations: a synchronous buck, fly-buck™ topology, single switch forward, two switch forward, bridge, resonant, and/or quasi-resonant.

9. The current booster as recited in claim 1, wherein the first switch includes a MOSFET.

10. The current booster as recited in claim 1, wherein the second switch includes at least one of a diode configured to switch based on duty cycle of the buck-type converter in the first and second modes without direct input from the controller; or a MOSFET.

11. The current booster as recited in claim 1, further comprising:
a load connected to be powered from the output node of the buck-type converter; and
a voltage source connected by a wireline to the input node of the buck-type converter for providing power to the load conditioned by the buck-type converter.

12. The current booster as recited in claim 11, wherein the load includes a motor, optionally wherein the motor is a brushless direct current motor (BLDC), optionally wherein the motor is connected to drive a downhole tool, optionally wherein the downhole tool includes at least one of a tractor, a drill, a mill, and/or a cutter.

13. A method of boosting current comprising:
supplying electrical power to a load through a current booster, wherein the current booster in a first mode maintains voltage applied to the load if current input to the current booster is below a set point, and wherein the current booster in a second mode maintains input current to the current booster if the input current to the current booster reaches the set point.

14. The method as recited in claim 13, wherein maintaining input current includes capping the input current in the second mode after input current to the current booster reaches the set point and thereafter returning the current booster to the first mode if demand from the load allows current to the current booster to drop below the set point.

15. The method as recited in claim 13, further comprising switching the current booster from the first mode to the second mode wherein the set point corresponds to a point of maximum power transfer through the current booster to the load.
